(19) United States
(12) Patent Application Publication
(10) Pub. No.: US 2008/0126467 A1
(43) Pub. Date: May 29, 2008

(54) Technique for transposing nonsymmetric sparse matrices

(76) Inventor: Anwar Ghuloum, Menlo Park, CA (US)

Correspondence Address: TROP PRUNER & HU, PC, 1616 S. VOSS ROAD, SUITE 750, HOUSTON, TX, 77057-2631, US

(21) Appl. No.: 11/527,356

(22) Filed: Sep. 26, 2006

(51) Int. Cl. G06F 17/16

(52) U.S. Cl. 708/520

(57) ABSTRACT

A technique includes receiving a compressed representation of a sparse matrix. The compressed representation is processed in parallel with multiple processors to generate a compressed representation of the sparse matrix transposed.

### BACKGROUND

The invention generally relates to a technique for transposing nonsymmetric sparse matrices.

Sparse matrix representations are common throughout physical modeling, machine learning and formulations of problems as differential equations. A sparse matrix is a matrix that has a significant number of zeros, as compared to the dimension of the matrix. Due to the large number of zeros, a sparse matrix may be represented in a compressed format for purposes of reducing the, storage and work that is required in processing the matrix.

It is common for computer applications to generate and use the transpose of a matrix. A matrix may be transposed by interchanging its rows and columns. A symmetric matrix is a matrix in which the original matrix and the transposed matrix are identical. Conventional techniques to transpose a non-sparse matrix may be relatively inefficient when applied to transposing a non-symmetric sparse matrix.

### BRIEF DESCRIPTION OF THE DRAWING

FIG. 1 is a flow diagram depicting a technique to transpose a nonsymmetric sparse matrix according to an embodiment of the invention.

FIG. 2 is a schematic diagram of a system to transpose a nonsymmetric sparse matrix according to an embodiment of the invention.

FIG. 3 is a flow diagram depicting a technique to transpose a nonsymmetric sparse matrix using parallel processing according to an embodiment of the invention.

FIG. 4 is a flow diagram depicting a technique to generate an array that indicates the first non-zero element of each row of a transposed matrix according to an embodiment of the invention.

FIG. 5 is a flow diagram of a technique to generate an offset vector used in the transposing of the nonsymmetric sparse matrix according to an embodiment of the invention.

FIG. 6 is a flow diagram depicting a technique to generate a transpermute vector used to transpose the nonsymmetric sparse matrix according to an embodiment of the invention.

FIG. 7 is a flow diagram depicting a technique to generate an array indicative of column positions of the nonzeros of transposed matrix according to an embodiment of the invention.

FIG. 8 is a flow diagram depicting a technique to generate an array indicating nonzeros of the transposed matrix according to an embodiment of the invention.

### DETAILED DESCRIPTION

In accordance with embodiments of the invention described herein, parallel processing is used to transpose a non-symmetric sparse matrix (also called a “source matrix” herein). Due to the parallel processing, the time to transpose the source matrix is greatly reduced, as compared to serial processing; and additionally, the technique is scalable with future generations of parallel processing architecture.

In the following description, the source matrix is represented in a compressed format. More specifically, in a compressed sparse row (SCR) representation, the source matrix is completely described using three arrays. The first array, called the “Nonzeros array,” sets forth the nonzeros of the source matrix. Another array, called the “ColumnIndices array,” indicates the specific column positions of the nonzeros. A third array, called the “Rows array,” indicates the first nonzero of each of row. Alternatively, the Rows array may indicate the size of each row of the source matrix.

For purposes of clarifying the following discussion, the following exemplary nonsymmetric sparse matrix (called the “exemplary source matrix” herein) to illustrate operations that are used to transpose the matrix:

$$\begin{matrix}0 & 1 & 0 & 0 & 0 \\ 2 & 0 & 3 & 4 & 0 \\ 0 & 5 & 0 & 0 & 6 \\ 0 & 7 & 0 & 0 & 8 \\ 0 & 0 & 9 & 0 & 0\end{matrix}$$

It is noted that other non-symmetric sparse matrices may be processed according to the techniques described herein, in accordance with embodiments of the invention. For the exemplary source matrix, the transpose is as follows:

$$\begin{matrix}0 & 2 & 0 & 0 & 0 \\ 1 & 0 & 5 & 7 & 0 \\ 0 & 3 & 0 & 0 & 9 \\ 0 & 4 & 0 & 0 & 0 \\ 0 & 0 & 6 & 8 & 0\end{matrix}$$

Pursuant to the CSR representation format, the nonsymmetric sparse matrix may be described as follows:

| | |
|---|---|
| Nonzeros: | [1 2 3 4 5 6 7 8 9] |
| ColumnIndices: | [1 0 2 3 1 4 1 4 2] |
| Rows: | [0 1 4 6 9] |
| Length: | 9 |

For this example, the Nonzeros array sets forth all nine nonzeros of the exemplary source matrix. Due to the nine nonzeros, the Nonzeros array has a length of “9.” The ColumnIndices array, of the same length as the Nonzeros array, sets forth the column position of each nonzero of the Nonzeros array. For example, assuming the array elements in the CSR representation are indexed from 0 to 8, element two of the ColumnIndices array, corresponds to element two, a “3,” of the Nonzeros array. This means that the “3” in the exemplary source matrix is located in column number two of the matrix. Similarly, element eight of the ColumnIndices array, a “2,” indicates that element eight of the Nonzeros array, a “9,” is located in column two of the exemplary source matrix.

Pursuant to the CSR representation, the Rows array denotes the first nonzero element in each row. In this regard, the Rows array includes five elements, each of which corresponds to a row (five total) of the exemplary source matrix. Each element of the Rows array is associated with a particular row and indicates the first nonzero element for that row. For example, element three of the Rows array, a “6,” is associated with row three of the sparse matrix and indicates that element six in the Nonzeros array, a “7,” is the first nonzero element in row three.

The CSR representation is an example of a compressed representation for a sparse matrix in accordance with some embodiments of the invention. However, it is noted that other compressed representations may be used in other embodiments of the invention. For example, a compressed sparse column (CSC) representation may alternatively be used in other embodiments of the invention. The exemplary source matrix has the following CSC representation:

| | |
|---|---|
| Nonzeros: | [2 1 5 7 4 9 5 6 8] |
| RowIndices: | [1 0 2 3 1 4 1 2 3] |
| Cols: | [0 1 4 6 7] |
| Length: | 9 |

The main difference between the CSR and CSC representations is that the nonzeros are in column order in the CSC representation. The CSC representation contains a Nonzeros array, which indicates the nonzeros of the sparse matrix, and the CSC representations also contains an array called the “RowIndices array,” which indicates the row positions of each corresponding nonzero in the Nonzeros array. Thus, element five of the RowIndices array, a “4,” indicates that element five of the Nonzeros array, a “9,” is located in row four of the exemplary sparse matrix. In the CSC representation, the RowIndices array replaces the ColumnIndices array of the CSR representation. The CSC representation also includes an array called the “Cols array,” which indicates the first nonzero element in each column. For example, element one of the Cols array, a “1,” indicates that a “1,” which is at element one in the Nonzeros array, is the first element in column one of the sparse matrix.

It is noted that the CSR representation of the transpose of the source matrix is identical to the CSC representation of the source matrix (accounting for any change of naming convention).

For purposes of simplifying the discussion herein, the CSR representation is assumed, although other representations (such as the CSC representation) may be used in other embodiments of the invention, as these representations fall within the scope of the appended claims.

As described further below, the computation of the transpose relies on several primitives, each of which may be executed in parallel. These primitives may be viewed as composible patterns of parallel computation, so that the technique may be readily applied in designing a lower level, explicitly threaded and/or vectorized implementation.

In the discussion below, the number of nonzeros in the source matrix is referred to as. “n,” the number of processors that are used to perform the transpose is referred to as “p,” and the number of rows in the source matrix is referred to as “r.” It is also assumed, for purposes of simplifying the discussion herein, that the source matrix is square, although non-square matrices may be processed in accordance with other embodiments of the invention.

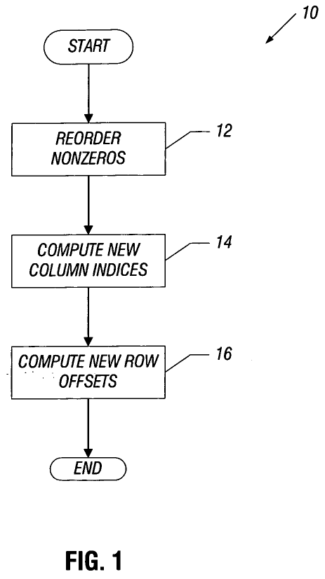

FIG. 1 depicts a technique 10 that may be generally be followed to compute the transpose of a source matrix, which is represented in the CSR representation. Pursuant to the technique 10, the nonzeros are reordered (block 12) and new column indices are computed, pursuant to block 14. Additionally, in computing the transpose, new row offsets are computed, pursuant to block 16.

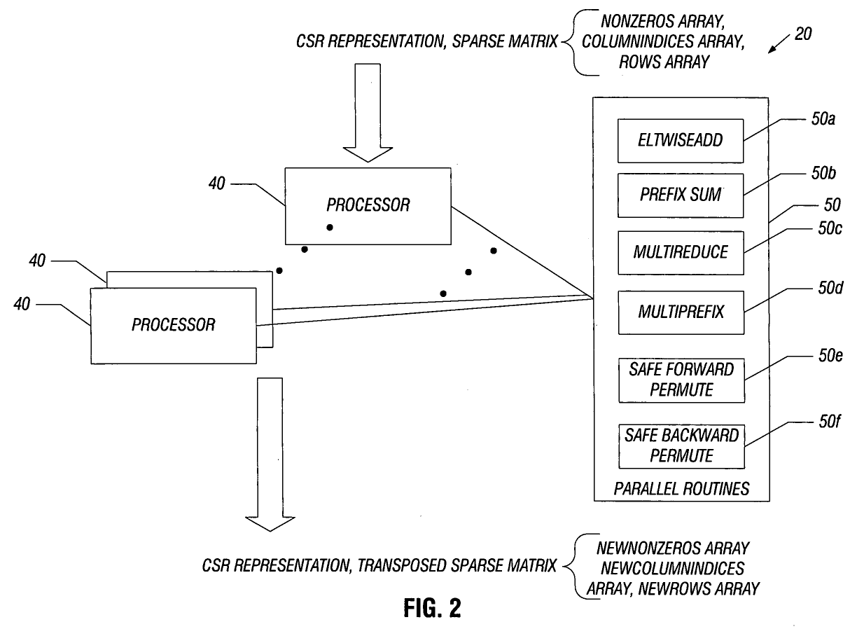

FIG. 2 depicts a parallel processing system 20 which may be used for purposes of generating the transpose of a nonsymmetric sparse matrix according to embodiments of the invention. In general, the system 20 includes multiple processors 40, which may be cores (of one or more multicore processor packages, for example), hardware threads, a number of cores that are not currently busy, or a number that is greater than the number of hardware threads (to facilitate load balancing). Thus, the processors 40 may take on numerous different forms, depending on the particular embodiment of the invention. Regardless of the form, however, the processors 40 process certain primitives in parallel for purposes of transposing the nonsymmetric sparse matrix (herein called “the source matrix”).

More specifically, in accordance with some embodiments of the invention, the processors 40 receive a CSR representation of the source matrix, a representation which includes the Nonzeros array, ColumnIndices array and the Rows array; and the processors 40 execute primitives 50 to generate a CSR representation of the transpose. The CSR representation of the transpose is associated with a newNonzeros array, a newColumnIndices array, and a newRows array, which correspond to the Nonzeros array, ColumnIndices array and Rows array, respectively, of the CSR representation of the source matrix. The computation of the newNonzeros array, newColumnIndices array and newRows array are set forth below for a specific example. In accordance with some embodiments of the invention, the processors 40 execute the following primitives 50, which are described in more detail below: an element wise add primitive 50a, a prefixsum primitive 50b, a multireduce primitive 50c, a multiprefix primitive 50d, a safe forward permute primitive 50e and a safe backward permute primitive 50f.

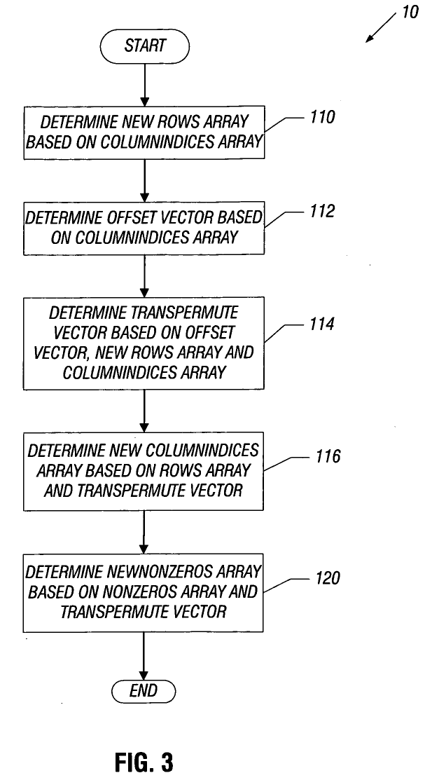

FIG. 3 depicts a technique that is generally performed by the multiple processors 40 for purposes of transposing the source matrix. Referring to FIG. 3 in conjunction with FIG. 2, pursuant to the technique 100, the processors 40 determine (block 110) the newRows array based on the ColumnIndices array. The processors 40 also determine two vectors, which aid in computing the transpose: an offset vector that describes the running number of elements in each column; and a transpermute vector that describes which nonzeros get permuted, as further described below. As depicted in blocks 112 and 114, the processors 40 determine the offset vector based on the ColumnIndices array and determine the transpermute vector based on the offset vector, the newRows array and the ColumnIndices array. After the offset and transpermute vectors are determined, the processors 40 determine in parallel the newColumnIndices array based on the Rows array and the transpermute vector, pursuant to block 116. Finally, the processors 40 determine in parallel the newNonzeros array based on the Nonzeros array and the transpermute vector, pursuant to block 120.

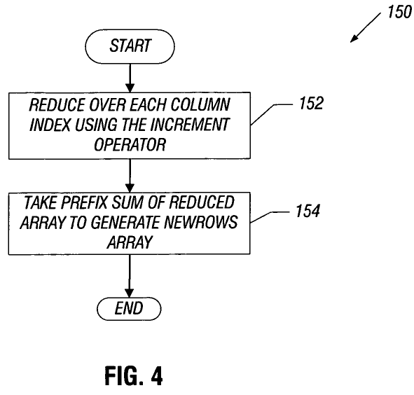

Referring to FIG. 4, in accordance with some embodiments of the invention, the processors 40 perform a technique 150 for purposes of determine the newRows array. Pursuant to the technique 150, the processors reduce (block 152) over each column index using the increment operator and take (block 154) the prefix sum of the reduced array to generate the newRows array. Using the exemplary source matrix as a more specific example, the following pseudo code may represent the operations 152 and 154 in accordance with some embodiments of the invention:

$$\begin{matrix}newRows = prefixSum ( “ + ” , multiReduce ( “ + 1 ” , ColumnIndices ) ) \\ = prefixSum ( “ + ” , multiReduce ( “ + 1 ” , [ 1 \; 0 \; 2 \; 3 \; 1 \; 4 \; 1 \; 4 \; 2 ] ) ) \\ = prefixSum ( “ + ” , [ 1 \; 3 \; 2 \; 1 \; 2 ] ) \\ = [ 0 \; 1 \; 4 \; 6 \; 7 ]\end{matrix}$$

The processors 40 execute the prefixSum primitive 50b to sum all of the elements of the array are summed, while keeping all partial sums. Serially, the prefixSum primitive 50b may be described by the following pseudo code:

C = prefixSum(“+”, A)
for (int I = 0; I < n; i++) {
C[A[i]] = C[A[i]]+1;
}

In the above pseudo code, the length of each of the C and A matrices is “n.” The prefixSum primitive 50b is executed in parallel by the multiple processors 40, an execution in which p threads are spawned off, and where each thread is responsible for computing a portion of the overall computation. This computation proceeds in three logical phases. The pseudo code, which describes the parallel execution of the prefixSum primitive 50b by the processors 40 is set forth below:

```
typeof(C) partialSums[p];
int frontier;
parallelfor (t = 0; t < p; t++) {
  for (i = (n/p)*t+1; i < (n/p)*(t+1); i++) {
    C[i] = A[i−1] + C[i−1];
  }
  partialSums[t] = A[i] + C[i];
}
for (frontier = 1; frontier < p; frontier = frontier * 2) {
  parallelfor (t = frontier + 1; t < p; t++) {
    partialsums[t] += partialsums[t−frontier];
  }
}
parrallelfor (t = 1; t<p; t++) {
  for (i = (n/p)*t; i < (n/p)*(t+1); i++) {
    C[i] = partialsums[t] + C[i];
  }
}
```

The total time to execute p threads in parallel is (n/p−1)+log₂(p)+(n/p)=2*(n/p)+log₂(p)−1. If the length of n is much greater than p, then the term n/p dominates and thus, scales linearly with p.

Regarding the multiReduce primitive 50c (see also FIG. 2), this particular primitive applies the function “+1” (i.e., the increment operator) to each element of a matrix C using a matrix A as the index. The multiReduce primitive 50c computes the count of each index that occurs in A and stores the result in a matrix C. Serially, the multiReduce primitive may be described by the following pseudo code:

```
  C = multiReduce(“+1”, A)
  for (int I = 0; I < n; i++) {
    C[A[i]] = C[A[i]]+1;
}
```

In the above pseudo code, the matrix A has a length of “n,” the matrix C has a length of “m,” and the indices in the matrix A fall within the range 0 . . . m. The processors 40 execute the multiReduce primitive 50c in parallel by spawning off p threads where each thread is responsible for computing a portion of the overall computation. The overall computation by the processors proceeds in three logical phases, which is described by the following pseudo code:

```
typeof(C) partialSums[p][m];
int frontier;
parallelfor (t = 0; t < p; t++) {
  for (i = (n/p)*t; i < (n/p)*(t+1); i++) {
    partialSums[t][A[i]] = partialSums[t][A[i]]+1;
  }
}
for (frontier = 1; frontier < p; frontier = frontier * 2) {
  parallelfor (t = frontier + 1; t < p; t++) {
    for (j = 0; j < m; j++) {
      partialSums[t][j] = partialSums[t−frontier][j] + partialSums[t][j];
    }
  }
}
C = partialSums[t];
```

The total time to execute the multiReduce primitive 50c with p threads in parallel is (n/p)+m*log 2(p). If the length of n is much greater than m*log 2(p), then the term n/p dominates and this scales linearly with p. If the length of n is not much greater than m*log 2(p), then a filter may be used on the second phase of the computation that only updates those components of partialSums[t] that were last updated. This reduces the complexity to at most m, so the requirement relaxes to n/p being greater than m, which is typical.

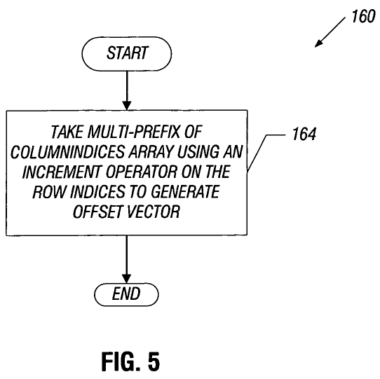

FIG. 5 depicts a technique 160 to generate the offset vector according to an embodiment of the invention. The technique 160 includes taking (block 164) the multiprefix of the ColumnIndices array using an increment operator on the RowIndices to generate the offset vector. Using the exemplary source matrix, in pseudo code, block 164 may be described as follows:

$$\begin{matrix}offset = multiPrefix ( “ + 1 ” , ColumnIndices ) \\ = multiPrefix ( “ + 1 ” , [ 1 \; 0 \; 2 \; 3 \; 1 \; 4 \; 1 \; 4 \; 2 ] ) \\ = [ 0 \; 0 \; 0 \; 0 \; 1 \; 0 \; 2 \; 1 \; 1 ]\end{matrix}$$

The multiprefix primitive 50d is similar to the multiReduce primitive 50c described above, except that the multiprefix primitive 50d keeps track of the partial count at each element of the matrix A. Serially, the multiprefix primitive 50d may be described by the following pseudo code:

```
C = multiPrefix(“+1”, A)
  Int sums[m];
  for (int I = 0; I < n; i++) {
  C[i] = sums[A[i]];
  sums[A[i]] = sums[A[i]]+1;
}
```

In the above pseudo code, the matrix A has a length of “n,” the matrix C has a length of “m,” and the indices in the matrix A fall within the range 0 . . . m. The processors 40 perform the multiPrefix primitive 50d in parallel, in which p threads are spawned off and each is responsible for computing a portion of the overall computation. The overall computation proceeds in three logical phases and may be described by the following pseudo code:

```
typeof(C) partialSums[p][m];
int frontier;
parallelfor (t = 0; t < p; t++) {
  for (i = (n/p)*t; i < (n/p)*(t+1); i++) {
    C[i] = partialSums[t][A[i]];
    partialSums[t][A[i]] = partialSums[t][A[i]]+1;
  }
}
for (frontier = 1; frontier < p; frontier = frontier * 2) {
  parallelfor (t = frontier + 1; t < p; t++) {
    for (j = 0; j < m; j++) {
      partialSums[t][j] = partialSums[t−frontier][j] + partialSums[t][j];
    }
  }
}
parrallelfor (t = 1; t<p; t++) {
  for (i = (n/p)*t; i < (n/p)*(t+1); i++) {
    C[i] = partialsums[t−1][A[i]] + C[i];
  }
}
```

The total time complexity here if p threads are executed in parallel is (n/p)+m*log 2(p)+(n/p=2*(n/p)+m*log 2(p). If the length of n is much greater than m*log 2(p), then the term n/p dominates and this scales linearly with p. If the length of n is not much greater than (n/p)+m*log 2(p), then we can use a filter on the second phase of the computation that only updates those components of partialSums[t] that were last updated. This reduces the complexity to at most m, so the requirement relaxes to n/p being greater than m, which is typical.

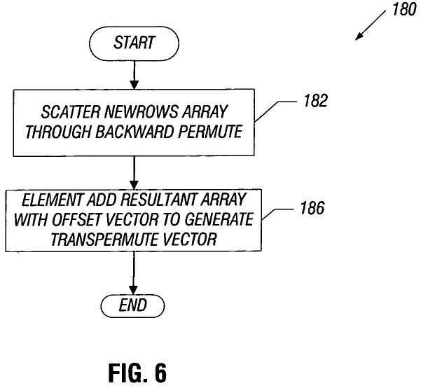

Referring to FIG. 6, in accordance with some embodiments of the invention, a technique 180 may be used for purposes of generating the transpermute vector. Pursuant to the technique 180, the newRows array is scattered (block 182) through a backward permute operation. The resultant array is element added (block 186) with the offset vector to generate the transpermute vector.

More specifically, the generation of the transpermute vector may be described by the following pseudo code, which uses the exemplary source matrix for a more specific example:

$$\begin{matrix}transpermute = eltwiseAdd ( offset , safeBackwardPermute \\ ( newRows , ColumnIndices ) ) \\ = eltwiseAdd ( [ 0 \; 0 \; 0 \; 0 \; 1 \; 0 \; 2 \; 1 \; 1 ] , safeBackwardPermute \\ ( [ 0 \; 1 \; 4 \; 6 \; 7 ] , [ 1 \; 0 \; 2 \; 3 \; 1 \; 4 \; 1 \; 4 \; 2 ] ) ) \\ = eltwiseAdd ( [ 0 \; 0 \; 0 \; 0 \; 1 \; 0 \; 2 \; 1 \; 1 ] , [ 1 \; 0 \; 4 \; 6 \; 1 \; 7 \; 1 \; 7 \; 4 ] ) \\ = [ 1 \; 0 \; 4 \; 6 \; 2 \; 7 \; 3 \; 8 \; 5 ]\end{matrix}$$

The eltwiseAdd primitive 50a (see FIG. 2) adds the elements of two matrices A and B together to generate the elements of a matrix C, as described in the following serial pseudo code:

C = eltwiseAdd(A, B) /* Length of A, B, C is n */
for (int I = 0; I < n; i++) {
C[i] = A[i] + B[i];
}

In the pseudo code that is set forth above, the matrices A, B and C each have a length of “n.” The length of the processors 40 execute the eltwiseAdd primitive 50a in parallel, as p threads are spawned off, and each thread is responsible for computing a portion of the overall computation of size n/p. This means that the algorithm scales linearly with the number of processors 40 since the time to complete across the threads is n/p. The parallel computation may be described by the following pseudo code:

```
parallelfor (t = 0; t < p; t++) {
  for (i = (n/p)*t; i < (n/p)*(t+1); i++) {
    C[i] = A[i] + B[i];
  }
}
```

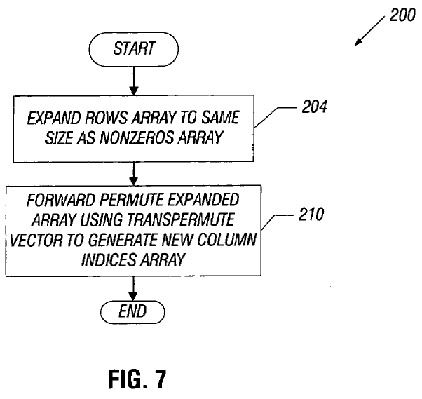

Referring to FIG. 7, in accordance with some embodiments of the invention, the processors 40 use a technique 200 to generate the newColumnIndices array. Pursuant to the technique 200, the Rows array is expanded (block 204) to the same size as the Nonzeros array. Subsequently, the expanded array is forward permuted (block 210) using the transpermute vector to generate the newColumnIndices array.

The pseudo code related to computing the newColumnIndices, with the specific example given for the exemplary source matrix, is set forth below:

$$\begin{matrix}newColumnIndices = safeForwardPermute ( prefixSum ( “ + ” , \\ safeBackwardPermute ( Index ( 5 ) , Row ) ) , \\ transpermute ) \\ = safeForwardPermute ( prefixSum ( “ + ” , \\ safeBackwardPermute ( [ 0 \; 1 \; 2 \; 3 \; 4 ] , \\ [ 0 \; 1 \; 4 \; 6 \; 8 ] ) ) , [ 1 \; 0 \; 4 \; 6 \; 2 \; 7 \; 3 \; 8 \; 5 ] ) \\ = safeForwardPermute ( prefixSum ( “ + ” , \\ [ 0 \; 1 \; 0 \; 0 \; 2 \; 0 \; 3 \; 0 \; 4 ] ) , [ 1 \; 0 \; 4 \; 6 \; 2 \; 7 \; 3 \; 8 ] ) \\ = safeForwardPermute ( [ 0 \; 1 \; 1 \; 1 \; 2 \; 2 \; 3 \; 3 \; 4 ] , \\ [ 1 \; 0 \; 4 \; 6 \; 2 \; 7 \; 3 \; 8 \; 5 ] ) \\ = [ 1 \; 0 \; 2 \; 3 \; 1 \; 4 \; 1 \; 2 \; 3 ]\end{matrix}$$

The safeForwardPermute primitive 50e is described as follows. The length of each of the A and Ind matrices is n, the indices in Ind fall within the range of 0 . . . (m−1), and the length of the C matrix is m. Serially, the safeForwardPermute primitive may be described as follows:

```
C = safeForwardPermute (A,Ind)
  for (int I = 0; I < n; i++) {
    C[Ind[i]] = A[i];
  }
```

The processors 40 execute the safeForwardPermute primitive 50e in parallel by spawning off p threads, where each thread is responsible for computing a portion of the overall computation of size n/p. This means that the algorithm scales linearly with the number of processors since to complete across the threads is n/p. Because Ind has no repetitions, each write to the C matrix is guaranteed not to conflict. The parallel implementation of the safeForwardPermute primitive may be described by the following pseudo code:

```
parallelfor (t = 0; t < p; t++) {
  for (i = (n/p)*t; i < (n/p)*(t+1); i++) {
    C[Ind[i]] = A[i];
  }
}
```

The safeBackwardPermute primitive 50f (see FIG. 2) may be described as follows: the length of each of the C and Ind matrices is n, the indices in the Ind matrix fall within the range 0 . . . (m−1), and the length of the A matrix is m. It does not matter whether or not there are repetitions in the Ind matrix. Serially, the safeBackwardPermute primitive 50f may be described as follows:

C = safeBackwardPermute (A,Ind)
for (int I = 0; I < n; i++) {
C[i] = A[Ind[i]];
}

The processors 40 execute the safeBackwardPermute primitive 50f in a parallel fashion by spawning off p threads, where its thread is responsible for computing a portion of the overall computation of size n/p. This means that the algorithm scales linearly with the number of processors since the time to completion across the threads is n/p.

Pseudo code, which describes the parallel computations, may be described as follows:

```
parallelfor (t = 0; t < p; t++) {
  for (i = (n/p)*t; i < (n/p)*(t+1); i++) {
    C[i] = A[Ind[i]];
  }
}
```

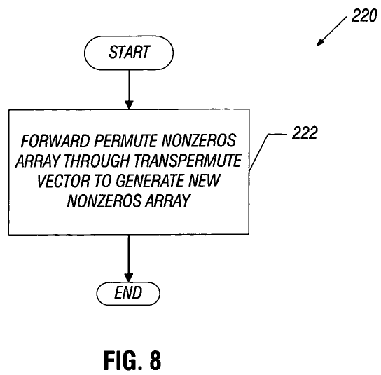

Referring to FIG. 8, in accordance with some embodiments of the invention, the processors 40 may perform a technique 220 for purposes of generating the newNonzeros array. Pursuant to the technique 220, the Nonzeros array is forward permuted (block 222) through the transpermute vector to generate the newNonzeros array.

In terms of pseudo code, the processors 40 perform the following operation with a specific example being given for the exemplary source matrix that is set forth herein:

$$\begin{matrix}newNonzeros = safeForwardPermute ( Nonzeros , transpermute ) \\ = safeForwardPermute ( [ 1 \; 2 \; 3 \; 4 \; 5 \; 6 \; 7 \; 8 \; 9 ] , \\ [ 1 \; 0 \; 4 \; 6 \; 2 \; 7 \; 3 \; 8 \; 5 ] ) \\ = [ 2 \; 1 \; 5 \; 7 \; 3 \; 9 \; 4 \; 6 \; 8 ]\end{matrix}$$

While the invention has been disclosed with respect to a limited number of embodiments, those skilled in the art, having the benefit of this disclosure, will appreciate numerous modifications and variations therefrom. It is intended that the appended claims covet all such modifications and variations as fall within the true spirit and scope of the invention.

What is claimed is:

1. A method comprising:
receiving a compressed representation of a sparse matrix; and
processing the compressed representation in parallel with multiple processors to generate a compressed representation of the sparse matrix transposed.

2. The method of claim 1, wherein the compressed representation of the sparse matrix comprises a first array of non-zeros of the sparse matrix, a second array indicative of positions of the non-zeros in the sparse matrix and a third array indicative of the first non-zero element in each line of the array.

3. The method of claim 2, wherein the line comprises one of a row and a column.

4. The method of claim 2, wherein the compressed representation of the sparse matrix comprises one of a compressed sparse row representation and a compressed sparse column representation.

5. The method of claim 2, wherein the processing the compressed representation in parallel comprises:
expanding the second array to be the same size as the first array; and
forward permuting the expanded second array to generate an array indicative of positions of non-zeros in the transposition of the sparse matrix.

6. The method of claim 2, further comprising:
reducing the second array to generate an array indicative of the number of times each position is indicated in the second array;
summing elements of the array indicative of the number of times each position is indicated in the second array to generate an array indicative of the first non-zero element in each line of the transposition of the sparse matrix.

7. The method of claim 2, further comprising:
forward permuting the non-zeros of the sparse matrix to generate an array indicative of the first non-zero element in each line of the transposition of the sparse matrix.

8. A system comprising:
a plurality of processors to:
receive a compressed representation of a sparse matrix; and
process the compressed representation in parallel to generate a compressed representation of the sparse matrix transposed.

9. The system of claim 8, wherein the compressed representation of the sparse matrix comprises a first array of non-zeros of the sparse matrix, a second array indicative of positions of the non-zeros in the sparse matrix and a third array indicative of the first non-zero element in each line of the array.

10. The system of claim 9, wherein the compressed representation of the sparse matrix comprises one of a compressed sparse row representation and a compressed sparse column representation.

11. The system of claim 9, wherein the plurality of processors expand the second array to be the same size as the first array and forward permute the expanded second array to generate an array indicative of positions of non-zeros in the transposition of the sparse matrix.

12. The system of claim 9, wherein the plurality of processors reduce the second array to generate an array indicative of the number of times each position is indicated in the second array and sum elements of the array indicative of the number of time each position is indicated in the second array to generate an array indicative of the first non-zero element in each line of the transposition of the sparse matrix.

13. The system of claim 9, wherein the plurality of processors forward permute the non-zeros of the sparse matrix to generate an array indicated of the first non-zero element in each line of the transposition of the sparse matrix.

14. An article comprising a computer accessible storage medium storing instructions that when executed cause a processor-based system to:
receive a compressed representation of a sparse matrix; and
process the compressed representation in parallel on multiple processors to generate a compressed representation of the sparse matrix transposed.

15. The article of claim 14, wherein the compressed representation of the sparse matrix comprises a first array of non-zeros of the sparse matrix, a second array indicative of positions of the non-zeros in the sparse matrix and a third array indicative of the first non-zero element in each line of the array.

16. The article of claim 15, wherein the compressed representation of the sparse matrix comprises one of a compressed sparse row representation and a compressed sparse column representation.

17. The article of claim 15, the storage medium storing instructions that when executed cause the processor-based system to:
expand the second array to be the same size as the first array; and
forward permute the expanded second array to generate an array indicative of positions of non-zeros in the transposition of the sparse matrix.

18. The article of claim 15, the storage medium storing instructions that when executed cause the processor-based system to:
reduce the second array to generate an array indicative of the number of times each position is indicated in the second array;
sum elements of the array indicative of the number of time each position is indicated in the second array to generate an array indicative of the first non-zero element in each line of the transposition of the sparse matrix.

19. The article of claim 15, the storage medium storing instructions that when executed cause the processor-based system to:
forward permute the non-zeros of the sparse matrix to generate an array indicative of the first non-zero element in each line of the transposition of the sparse matrix.
